(19) United States
(12) Patent Application Publication
(10) Pub. No.: US 2012/0303588 A1
(43) Pub. Date: Nov. 29, 2012

(54) DATA DE-DUPLICATION PROCESSING METHOD FOR POINT-TO-POINT TRANSMISSION AND SYSTEM THEREOF

(76) Inventors: Wei Liu, Tianjin (CN); Chih-Peng Chen, Taipei (TW)

(21) Appl. No.: 13/242,512

(22) Filed: Sep. 23, 2011

(30) Foreign Application Priority Data
May 25, 2011 (CN) 201110145713.3

(51) Int. Cl. G06F 17/30

(52) U.S. Cl. 707/674; 707/E17.005

(57) ABSTRACT

A data de-duplication processing method for point-to-point transmission and a system thereof. An originating client sends a file recovery request to an information management server and a data storage server; obtaining a plurality of partitioned data blocks; if the partitioned data block in the file recovery request in the information management server, the information management server searches for the data storage server according to the file recovery request and returns the found data storage server and the partitioned data block belonging to the data storage server to the originating client as a response; if the partitioned data block in the file recovery request in a target client, the target client transports the partitioned data block to the originating client; the originating client performs data recovery of an input file on the partitioned data blocks according to the partitioned data blocks obtained from the target clients and the data storage server.

### CROSS-REFERENCE TO RELATED APPLICATIONS

This non-provisional application claims priority under 35 U.S.C. §119(a) on Patent Application No(s). 201110145713.3 filed in China, P.R.C. on May 25, 2011, the entire contents of which are hereby incorporated by reference.

### BACKGROUND OF THE INVENTION

1. Field of the Invention

The present invention relates to a data de-duplication method and a system thereof, and more particularly to a data de-duplication processing method for point-to-point transmission and a system thereof.

2. Related Art

Data de-duplication is a data reduction technology and generally used for a disk-based backup system for the main purpose of reducing storage capacity used in a storage system. A working mode of the data de-duplication is searching for duplicated data blocks of viable sizes at different locations in different files within a certain period of time. The duplicated data blocks may be replaced with an indicator. A large quantity of redundant data always exists in the storage system. In order to solve the problem to conserve more space, a de-duplication technology logically becomes a focus point of people. The de-duplication technology is of benefit to file backup in a client inside an enterprise (or in a Local Are Network (LAN)).

In the prior art, when the client intends to recover an input file, the client needs to send a file recovery request to a data storage server and obtain corresponding partitioned data blocks from the data storage server. Generally, a single data storage server may be set in the LAN. FIG. 1A is a schematic architecture diagram of the prior art. Referring to FIG. 1A, the single data storage server 110 needs to handle access requests sent by a plurality of clients 120, so a bandwidth of the data storage server is a key point of input file recovery. If the bandwidth of the data storage server is bigger, each client 120 can obtain desired partitioned data blocks more rapidly and perform a file recovery process. When the number of the clients 120 in the LAN becomes large, the bandwidth of the data storage server may be seriously used up. In this way, each client 120 cannot obtain the desired partitioned data blocks successfully.

Therefore, in order to solve the problem caused by the single data storage server, a concept of distributed data storage servers 110 is proposed. FIG. 1B is a schematic architecture diagram of distributed data storage servers in the prior art. Referring to FIG. 1B, the architecture has an information management server and a plurality of data storage servers 110. The information management server 130 is used to receive a request sent by a client 120, and select a suitable data storage server 110 according to operating statuses of the data storage servers 110. The selected data storage server 110 transmits partitioned data blocks to the client 120. In this access mode, the problem of an insufficient bandwidth of the data storage server 110 can be solved, but as a whole, the information management server 130 is a bottleneck of the whole system. The reason is that the information management server 130 not only needs to manage the operation for the client 120 to store and assign the partitioned data blocks in the data storage server 110, but also needs to transport the partitioned data blocks from the data storage server 110 to the client 120. Therefore, the distributed data storage servers still have an access limit.

### SUMMARY OF THE INVENTION

In view of the above problems, the present invention is a data de-duplication processing method for point-to-point transmission, applicable for an originating client to recover an input file after a data de-duplication procedure.

The present invention provides a data de-duplication processing method for point-to-point transmission, which comprises the following steps. A client for sending a file recovery request is defined as an originating client, and others are defined as target clients; after completing a data de-duplication procedure, the originating client or the target client registers partitioned data blocks belonging to the originating client or the target client on an information management server; the originating client sends the file recovery request to the information management server and a data storage server, for obtaining a plurality of partitioned data blocks of the input file; if the partitioned data block in the file recovery request exists in the information management server, the information management server searches for the data storage server according to the file recovery request and returns the found data storage server and the partitioned data block belonging to the data storage server to the originating client as a response; if the partitioned data block in the file recovery request exists in the target client, the target client transports the partitioned data block to the originating client; and the originating client performs data recovery of the input file on the partitioned data blocks according to the partitioned data blocks obtained from the target clients and the data storage server.

The present invention further provides a data de-duplication processing system for point-to-point transmission, which comprises at least one client, a data storage server and an information management server. The client performs a data de-duplication procedure on an input file, and generates partitioned data blocks corresponding to the input file. The client for sending a file recovery request is defined as an originating client, and others are target clients. If the partitioned data block in the file recovery request exists in the information management server, the information management server searches for the data storage server according to the file recovery request and returns the found data storage server and the partitioned data block belonging to the data storage server to the originating client as a response. If the partitioned data block in the file recovery request exists in the target client, the target client transports the partitioned data block to the originating client. The originating client performs data recovery of the input file on the partitioned data blocks according to the partitioned data blocks obtained from the target clients and the data storage server.

Through the data de-duplication processing method for the point-to-point transmission and the system thereof according to the present invention, the originating client not only can obtain the corresponding partitioned data blocks from the data storage server, but also can obtain other partitioned data blocks from other target clients. In this way, an access speed of the data recovery of the input file of the originating client is increased, thereby rapidly completing the recovery of the input file.

### BRIEF DESCRIPTION OF THE DRAWINGS

The present invention will become more fully understood from the detailed description given herein below for illustration only, and thus are not limitative of the present invention, and wherein:

FIG. 1A is a schematic architecture diagram of the prior art;

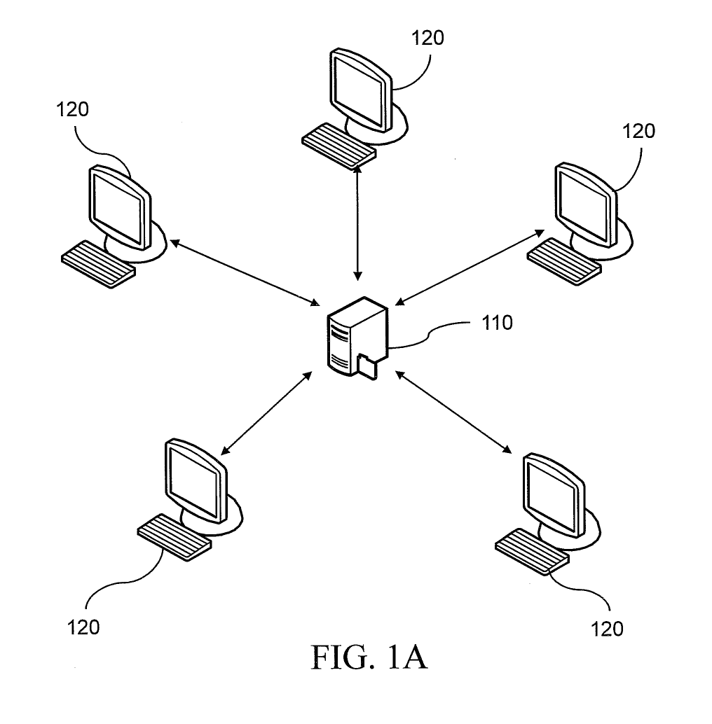

FIG. 1B is a schematic architecture diagram of distributed data storage servers in the prior art;

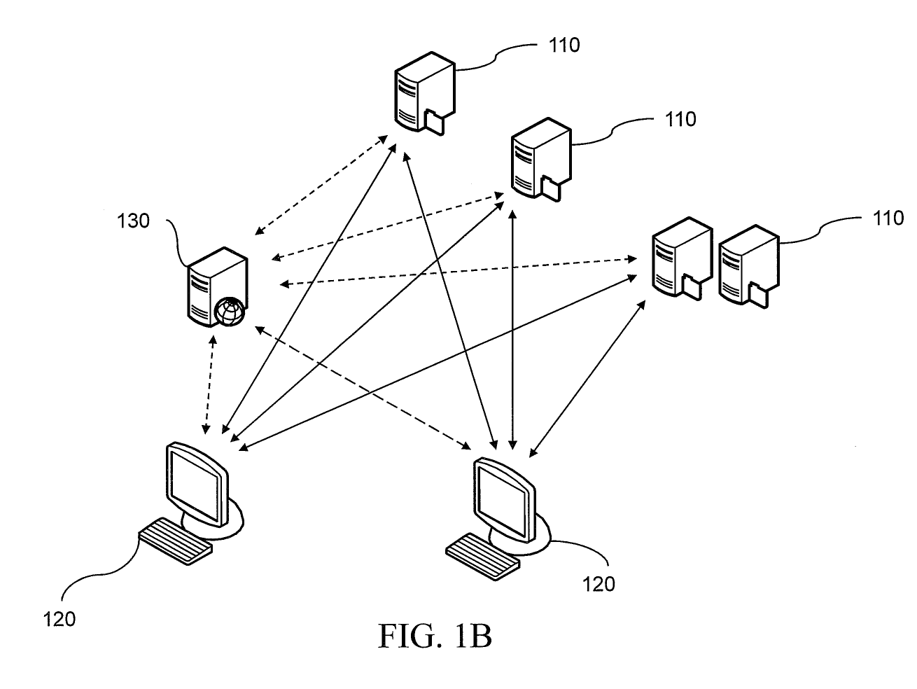

FIG. 2 is a schematic architecture diagram of the present invention;

FIG. 3 is a schematic flow chart of operation according to the present invention; and

FIG. 4 is a schematic diagram of operation for an originating client to obtain partitioned data blocks according to the present invention.

### DETAILED DESCRIPTION OF THE INVENTION

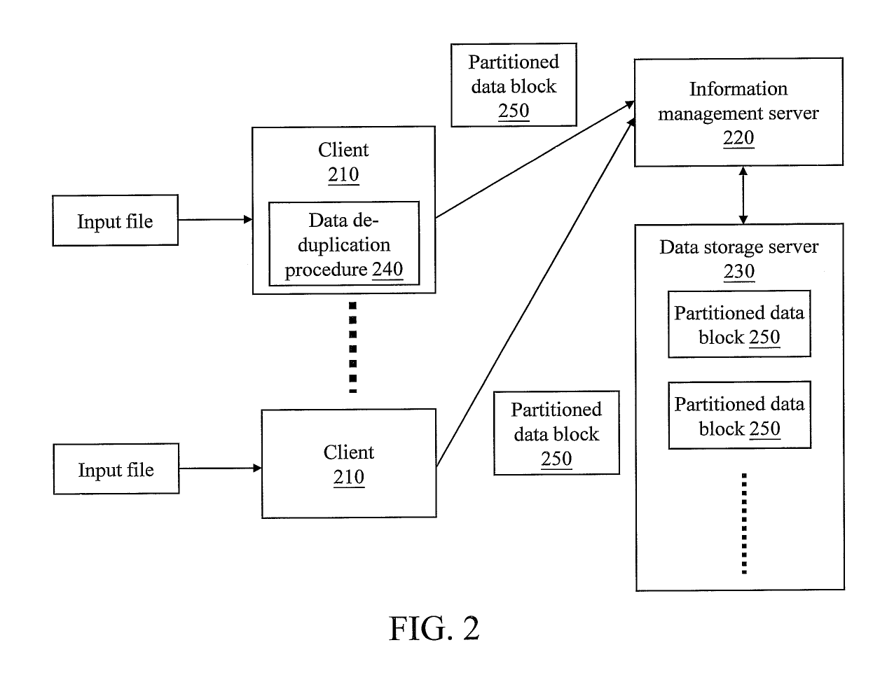

FIG. 2 is a schematic architecture diagram of the present invention. Referring to FIG. 2, a data de-duplication system according to the present invention comprises at least one client 210, a data storage server 220 and an information management server 230. The client 210 may be connected to the data storage server 220 and the information management server 230 through Internet or an intranet. The client 210 performs a data de-duplication procedure 240. After performing the data de-duplication procedure 240 on an input file, the client 210 generates corresponding partitioned data blocks 250.

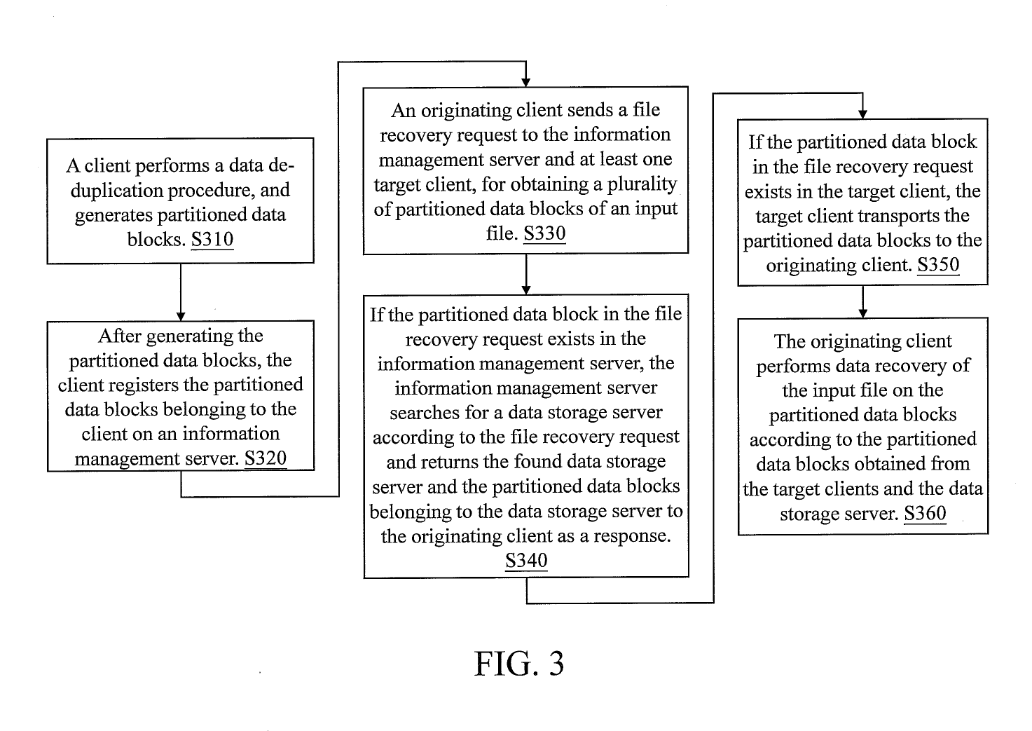

FIG. 3 is a schematic flow chart of operation according to the present invention.

In Step S310, a client performs a data de-duplication procedure, and generates partitioned data blocks.

In Step S320, after generating the partitioned data blocks, the client registers the partitioned data blocks belonging to the client on an information management server.

In Step S330, an originating client sends a file recovery request to the information management server and at least one target client, for obtaining a plurality of partitioned data blocks of an input file.

In Step S340, if the partitioned data block in the file recovery request exists in the information management server, the information management server searches for a data storage server according to the file recovery request and returns the found data storage server and the partitioned data blocks belonging to the data storage server to the originating client as a response.

In Step S350, if the partitioned data block in the file recovery request exists in the target client, the target client transports the partitioned data blocks to the originating client.

In Step S360, the originating client performs data recovery of the input file on the partitioned data blocks according to the partitioned data blocks obtained from the target clients and the data storage server.

First, the client 210 performs a partitioning process on the input file, and generates the plurality of partitioned data blocks 250 and hash values corresponding to the blocks. An algorithm for calculating the hash value may be SHA-1 or MD5. A partition algorithm for the partitioned data blocks 250 may be implemented through a fixed size partition or content defined chunking (CDC) manner. After generating the partitioned data blocks 250, the client 210 registers the partitioned data blocks 250 belonging to the client 210 on the information management server 230. The information management server 230 assigns the corresponding data storage server 220 to store the partitioned data blocks 250.

For clear illustration, the client 210 for sending the file recovery request is defined as an originating client 211, and others are target clients 212. Then, the originating client 211 intends to perform a file recovery process. The originating client 211 first sends the file recovery request to the information management server 230 and records the required partitioned data block 250 in the file recovery request. At the same time, the originating client 211 also sends the same file recovery request to other target clients 212.

The information management server 230 searches the corresponding data storage server 220 according to the file recovery request and returns an operation status (such as, a current transmission bandwidth, the number of partitioned data blocks 250, or an operation load value) of the data storage server 220 to the originating client 211 as a response. After receiving the file recovery request, the target client 212 searches whether the target client 212 has the required partitioned data block 250. If the target client 212 has the partitioned data block 250, the target client 212 returns a part of the partitioned data block 250 that the target client 212 has to the originating client 211 as a response. When responding to the originating client 211, the data storage server 220 and the target client 212 additionally transmit a transport estimate value, in which the transport estimate value records information such as the current transmission bandwidth, the number of partitioned data blocks 250, the operation load value and numbers of the partitioned data blocks 250.

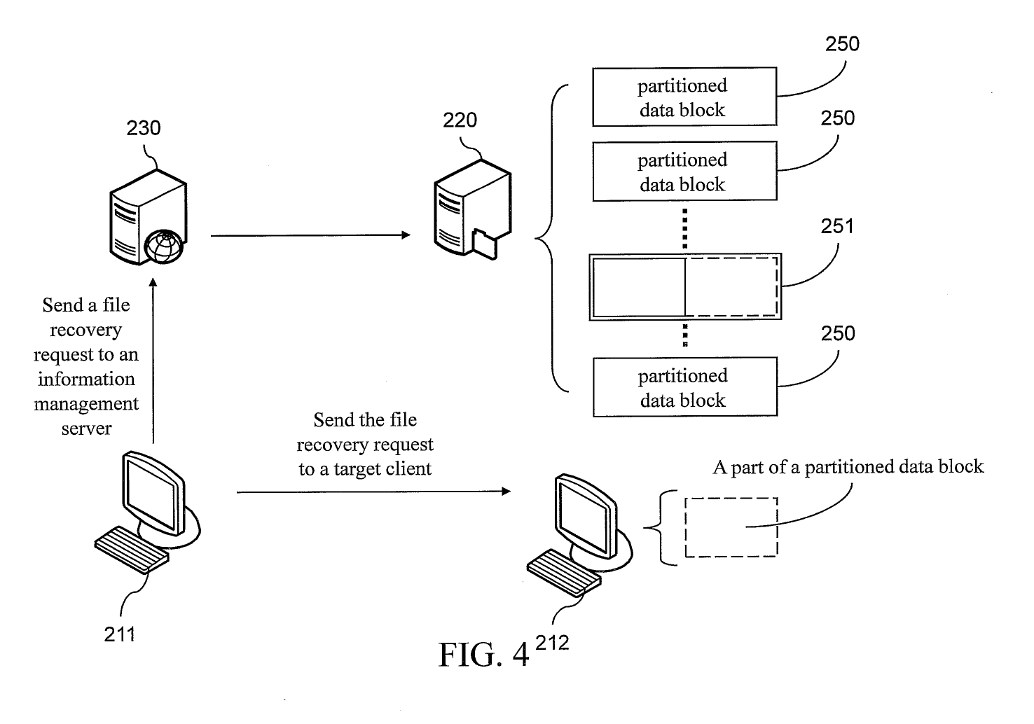

The originating client 211 decides to obtain different parts of the partitioned data block 250 from the target client 212 or the data storage server 220 according to the transport estimate value. For clear illustration of the transport process, reference is made to FIG. 4. FIG. 4 is a schematic diagram of operation for an originating client to obtain partitioned data blocks according to the present invention. In FIG. 4, the originating client 211 is Client A, the target client 212 is Client B, and the data storage server 220 has the partitioned data blocks 250 numbered from 1 to n.

If the originating client 211 intends to access a partitioned data block 251 numbered 10, the originating client 211 sends a file recovery request for demanding the partitioned data block 251 numbered 10 to the target client 212 or the data storage server 220. It is assumed that the data storage server 220 has the complete partitioned data block 251 numbered 10 and the target client 212 has a part of the partitioned data block 251 numbered 10 (a part in dashed box in FIG. 4).

If the data storage server 220 can completely provide the partitioned data block 250, the originating client 211 directly obtains the complete partitioned data block 251 numbered 10 from the data storage server 220. If the bandwidth (or load) of the data storage server 220 is fully loaded, the originating client 211 not only sends a request for obtaining a part of the partitioned data block 250 to the data storage server 220, but also sends a request for obtaining another part of the partitioned data block 250 to the target client 212. In a similar way, when other target clients 212 have different parts of the partitioned data block 250, the originating client 211 sends the file recovery request in a polling manner until obtaining all partitioned data blocks 250.

Finally, the originating client 211 performs the data recovery of the input file on the partitioned data blocks 250 according to the partitioned data blocks obtained from the target clients 212 and the data storage server 220.

Through the data de-duplication processing method for the point-to-point transmission and the system thereof according to the present invention, the originating client 211 not only can obtain the corresponding partitioned data blocks 250 from the data storage server 220, but also can obtain other partitioned data blocks 250 from other target clients 212. In this way, an access speed of the data recovery of the input file of the originating client 211 is increased, thereby rapidly completing the recovery of the input file.

What is claimed is:

1. A data de-duplication processing method for point-to-point transmission, applicable for an originating client to recover an input file after a data de-duplication procedure, comprising:
the originating client sending a file recovery request to an information management server and at least one target client, for obtaining a plurality of partitioned data blocks of the input file;
if the partitioned data block in the file recovery request exists in the information management server, the information management server searching for a data storage server according to the file recovery request and returning the found data storage server and the partitioned data block belonging to the data storage server to the originating client as a response;
if the partitioned data block in the file recovery request exists in the target client, the target client transporting the partitioned data block to the originating client; and
the originating client performing data recovery of the input file on the partitioned data blocks according to the partitioned data blocks obtained from the target clients and the data storage server.

2. The data de-duplication processing method for the point-to-point transmission according to claim 1, wherein the partitioned data blocks stored in the originating client are different from the partitioned data blocks stored in the target client.

3. The data de-duplication processing method for the point-to-point transmission according to claim 1, wherein after completing the data de-duplication procedure, the originating client or the target client registers the partitioned data blocks belonging to the originating client or the target client on the information management server.

4. The data de-duplication processing method for the point-to-point transmission according to claim 1, wherein the originating client decides to obtain the corresponding partitioned data block from the target client or the data storage server according to a transport estimate value.

5. A data de-duplication processing system for point-to-point transmission, applicable for a client to recover an input file after a data de-duplication procedure, comprising:
at least one client, performing the data de-duplication procedure on the input file and generating partitioned data blocks corresponding to the input file, wherein the client for sending a file recovery request is defined as an originating client, and others are target clients;
a data storage server, storing a plurality of partitioned data blocks; and
an information management server, recording the client having the partitioned data blocks,
wherein if the information management server records the partitioned data blocks in the file recovery request, the information management server searches for other target clients having the partitioned data blocks according to the file recovery request and returns the found target clients and the partitioned data blocks belonging to the target clients to the originating client as a response, and the originating client performs data recovery of the input file on the partitioned data blocks according to the partitioned data blocks obtained from the target clients and the data storage server.

6. The data de-duplication processing system for the point-to-point transmission according to claim 5, wherein after completing the data de-duplication procedure, the originating client or the target client registers the partitioned data blocks belonging to the originating client or the target client on the information management server.

7. The data de-duplication processing system for the point-to-point transmission according to claim 5, wherein the originating client decides to obtain the corresponding partitioned data block from the target client or the data storage server according to a transport estimate value.
